(19) United States
(12) Patent Application Publication
(10) Pub. No.: US 2011/0095702 A1
(43) Pub. Date: Apr. 28, 2011

(54) STACKED ORGANIC LIGHT-EMITTING DEVICE

(75) Inventors: Jeong Ik Lee, Gyeonggi-do (KR); Jong Hee Lee, Daejeon (KR); Chun Won Byun, Daejeon (KR); Hye Yong Chu, Daejeon (KR)

(73) Assignee: ELECTRONICS AND TELECOMMUNICATIONS RESEARCH INSTITUTE, Daejeon (KR)

(21) Appl. No.: 12/709,796

(22) Filed: Feb. 22, 2010

(30) Foreign Application Priority Data
Oct. 27, 2009 (KR) 10-2009-0102202

(51) Int. Cl. H05B 37/02

(52) U.S. Cl. 315/294

(57) ABSTRACT

A stacked organic light-emitting device is provided. The stacked organic light-emitting device includes a first electrode, first and second light-emitting units formed under and on the first electrode respectively, transparent or semi-transparent second and third electrodes formed under the first light-emitting unit and on the second light-emitting unit respectively, and having the same polarity, and a drive controller electrically connected with the first, second and third electrodes to connect the first and second light-emitting units in parallel, and capable of controlling at least one of the first and second light-emitting units to emit light. Accordingly, the organic light-emitting device has a lower driving voltage than a conventional stacked light-emitting device in which light-emitting units are serially connected.

### CROSS-REFERENCE TO RELATED APPLICATION

This application claims priority to and the benefit of Korean Patent Application No. 10-2009-0102202, filed Oct. 27, 2009, the disclosure of which is incorporated herein by reference in its entirety.

### BACKGROUND

1. Field of the Invention

The present invention relates to an organic light-emitting device, and more particularly, to a stacked organic light-emitting device in which two light-emitting units are stacked.

2. Discussion of Related Art

Lately, displays and lightings are undergoing requirements to become lightweight, thin, highly efficient, environmentally friendly, and so on. To meet these requirements, research on organic light-emitting diodes (OLEDs) is under way.

Light-emitting devices employing OLEDs are classified according to a few criteria as described below.

First, according to emission directions, light-emitting devices may be classified into a top-emitting type and a bottom-emitting type that emit light toward one side and a double-sided emitting type that emits light toward both sides. Light-emitting devices of the double-sided emitting type may be further classified into a transparent type and an opaque type.

Second, according to stack sequences, light-emitting devices may be classified into a standard type in which a substrate, an anode, a hole transport layer, a light-emitting layer, an electron transport layer, and a cathode are stacked in sequence, and an inverted type in which a substrate, a cathode, an electron transport layer, a light-emitting layer, a hole transport layer, and an anode are stacked in sequence.

Third, according to constitutions of light-emitting devices, the light-emitting devices may be classified into a single-type that includes one OLED unit, and a stacked (tandem) type in which two or more OLED units are stacked in series.

Among these OLEDs, the stacked OLED has a better stability and a longer life span than the single OLED and thus has been frequently researched and developed lately. The development trends will be described below.

In a first method, one anode and one cathode are included in an entire display, and a color is generated by various combinations of red, green and blue (RGB) layers. This method can accommodate only one of single-sided light-emitting and transparent double-sided light-emitting types, and cannot separately drive OLED units. In other words, although a stacked OLED has two or more units that can display a color, a display shows only a single color in which two or more colors are mixed to the outside. Also, the stacked OLED requires a higher driving voltage than a single OLED, and thus there is a problem in driving design.

In a second method, an anode and a cathode are included in each OLED unit to separately drive OLED units. The second method can express various colors in comparison with the first method. However, this method is available only to the single-sided light-emitting type. Also, since two OLED units are connected in series, the stacked OLED requires a higher driving voltage than a single OLED, and there is a problem in driving design.

Consequently, a technique is required for a stacked OLED to consume little power and control an emission direction to one side or both sides.

### SUMMARY OF THE INVENTION

The present invention is directed to a stacked organic light-emitting device that has light-emitting units connected in parallel and can be driven by a lower voltage than a conventional device in which light-emitting units are connected in series.

The present invention is also directed to a stacked organic light-emitting device that can control an emission direction in an upward direction, in a downward direction, or in both of the directions.

The present invention is also directed to a stacked organic light-emitting device capable of color control.

The present invention is also directed to a stacked organic light-emitting device that solves the problems of heat generation and voltage drop caused by a common electrode.

The present invention is also directed to a stacked organic light-emitting device that uses a minimum number of voltage regulation units during both side emission.

One aspect of the present invention provides a stacked organic light-emitting device including: a first electrode; first and second light-emitting units formed under and on the first electrode, respectively; transparent or semi-transparent second and third electrodes formed under the first light-emitting unit and on the second light-emitting unit respectively, and having the same polarity; and a drive controller electrically connected with the first, second and third electrodes to connect the first and second light-emitting units in parallel, and controlling the first and second light-emitting units to emit light at the same time or different times.

The drive controller may include: a first voltage regulation unit for regulating a voltage applied to the second electrode; and a second voltage regulation unit for regulating a voltage applied to the third electrode.

The drive controller may further include: a first electrode line for connecting the second electrode with the first voltage regulation unit; a second electrode line for connecting the third electrode with the second voltage regulation unit; a first diode for connecting the first electrode with the second electrode and arranged in a direction corresponding to a polarity of the first electrode; and a second diode for connecting the first electrode with the third electrode and arranged in a direction corresponding to the polarity of the first electrode.

The drive controller may further include an additional driving switch formed between the first electrode line and the second electrode line and enabling electrical on-off control so that both the first and second light-emitting units emit the light in an ON state of the first voltage regulation unit or the second voltage regulation unit.

The first electrode may be formed of an opaque, transparent, or semi-transparent material.

When the first electrode is formed of the opaque material, an emission direction may be controlled upward, downward, or in both of the directions by the drive controller.

When the first electrode is formed of the transparent or semi-transparent material and the first and second light-emitting units are formed of materials emitting the light of the same color, brightness may be adjusted by the drive controller.

When the first electrode is formed of the transparent or semi-transparent material and the first and second light-emitting units are formed of materials emitting the light of different colors, brightness and color may be adjusted by the drive controller.

The first light-emitting unit and the second light-emitting unit may have one structure selected from an organic light-emitting layer, a hole injection layer/organic light-emitting layer, an organic light-emitting layer/electron injection layer, a hole-injection layer/organic light-emitting layer/electron injection layer, a hole injection layer/hole transport layer/organic light-emitting layer/electron injection layer, a hole injection layer/organic light-emitting layer/electron transport layer/electron injection layer, and a hole injection layer/hole transport layer/organic light-emitting layer/electron transport layer/electron injection layer.

Another aspect of the present invention provides a stacked organic light-emitting device including: an insulating layer; first and second electrodes formed under and on the insulating layer respectively, and having the same polarity; first and second light-emitting units formed under the first electrode and on the second electrode, respectively; transparent or semi-transparent third and fourth electrodes formed under the first light-emitting unit and on the second light-emitting unit respectively, and having the same polarity; and a drive controller electrically connected with the first, second, third and fourth electrodes to connect the first and second light-emitting units in parallel, and capable of controlling at least one of the first and second light-emitting units to emit light.

The drive controller may include: a first voltage regulation unit for regulating a voltage applied to the third electrode; and a second voltage regulation unit for regulating a voltage applied to the fourth electrode.

The drive controller may further include: a first electrode line for connecting the third electrode with the first voltage regulation unit; a second electrode line for connecting the fourth electrode with the second voltage regulation unit; a first diode for connecting the first electrode with the third electrode and arranged in a direction corresponding to the polarity of the first electrode; and a second diode for connecting the second electrode with the fourth electrode and arranged in a direction corresponding to the polarity of the second electrode.

The drive controller may further include an additional driving switch formed between the first electrode line and the second electrode line and enabling electrical on-off control so that both the first and second light-emitting units emit the light in an ON state of the first voltage regulation unit or the second voltage regulation unit.

The first and second electrodes may be formed of an opaque, transparent, or semi-transparent material.

When the first and second electrodes are formed of the opaque material, an emission direction may be controlled in an upward direction, in a downward direction, or in both of the directions.

When the first and second electrodes are formed of the transparent or semi-transparent material and the first and second light-emitting units are formed of materials emitting the light of the same color, brightness may be adjusted by the drive controller.

When the first and second electrodes are formed of the transparent or semi-transparent material and the first and second light-emitting units are formed of materials emitting the light of different colors, brightness and color may be adjusted by the drive controller.

A thickness of the insulating layer may be determined based on a transmissivity and refractive index of the insulating layer and an optical length of the first and second light-emitting units so that an amount and color of the light can be adjusted due to a microcavity effect.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 illustrates a stacked organic light-emitting device according to an exemplary embodiment of the present invention;

FIG. 2 illustrates emission direction control of a stacked organic light-emitting device according to an exemplary embodiment of the present invention;

FIG. 3 illustrates brightness control of a stacked organic light-emitting device according to an exemplary embodiment of the present invention;

FIG. 4 illustrates color control of a stacked organic light-emitting device according to an exemplary embodiment of the present invention;

FIG. 5 illustrates a stacked organic light-emitting device in which an insulating layer is inserted according to an exemplary embodiment of the present invention; and

FIG. 6 illustrates a stacked organic light-emitting device in which an additional driving switch is formed according to another exemplary embodiment of the present invention.

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention.

As described above, a conventional stacked organic light-emitting device has problems in that it requires double the applied voltage of a single organic light-emitting device and cannot control an emission direction.

To solve these problems, the present invention provides a stacked organic light-emitting device that includes light-emitting units connected in parallel and thus can be driven at a lower voltage than a conventional device in which light-emitting units are serially connected and control an emission direction in an upward or downward direction, or both.

Also, the present invention provides a stacked organic light-emitting device that can control a color by diversifying the colors of respective light-emitting units and regulating an applied voltage.

Also, the present invention provides a stacked organic light-emitting device that has an insulating layer formed between common electrodes to solve the problems of heat generation and voltage drop caused by the common electrode.

Also, the present invention provides a stacked organic light-emitting device that uses a minimum number of voltage regulation units during both side emission.

Meanwhile, an organic light-emitting device according to an exemplary embodiment of the present invention may have a structure in which an inverted organic light-emitting diode (OLED) is stacked on a standard OLED, or vice versa.

Exemplary embodiments of the present invention will be described in detail below with reference to the attached drawings.

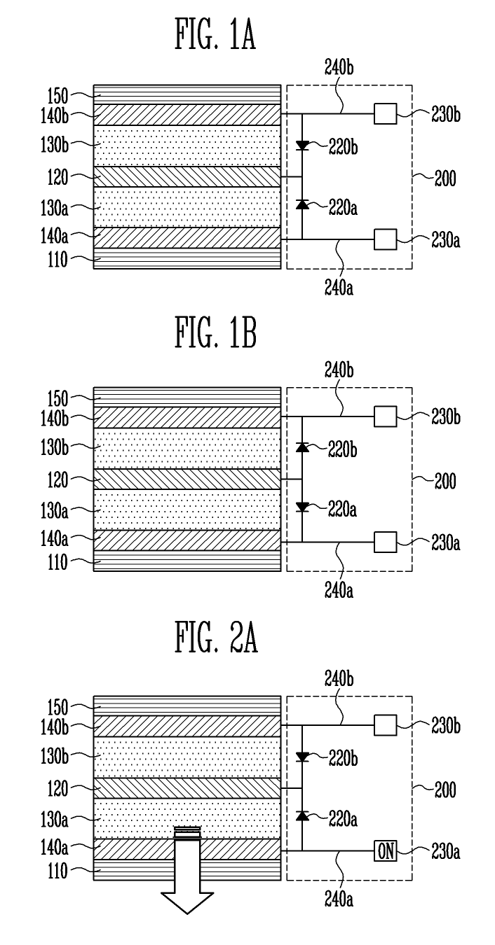

FIG. 1 illustrates a stacked organic light-emitting device according to an exemplary embodiment of the present invention.

FIG. 1A illustrates a case in which a first electrode 120, which is a common electrode, functions as a cathode, and a second electrode 140a and a third electrode 140b function as anodes, and FIG. 1B illustrates a case in which the first electrode 120, which is the common electrode, functions as an anode, and the second electrode 140a and the third electrode 140b function as cathodes. Diodes 220a and 220b are arranged in an appropriate direction for the polarity of the first electrode 120.

For convenience, various exemplary embodiments for the case of FIG. 1A in which the first electrode 120 which is a common electrode functions as a cathode will be described below. However, the present invention is not limited to the case in which the first electrode 120, which is a common electrode, functions as a cathode, and the exemplary embodiments described below can be applied to the case of FIG. 1B in which the first electrode 120, which is a common electrode, functions as an anode.

Referring to FIG. 1A, a stacked organic light-emitting device according to an exemplary embodiment of the present invention includes a first electrode 120, a first light-emitting unit 130a formed under the first electrode 120, a second electrode 140a formed under the first light-emitting unit 130a, a second light-emitting unit 130b formed on the first electrode 120, a third electrode 140b formed on the second light-emitting unit 130b, a substrate 110 formed under the second electrode 140a, an encapsulation substrate 150 formed on the third electrode 140b, and a drive controller 200 connected with the first electrode 120, the second electrode 140a, and the third electrode 140b.

The first electrode 120 is formed between the first light-emitting unit 130a and the second light-emitting unit 130b, and functions as a common electrode of the first light-emitting unit 130a and the second light-emitting unit 130b. As described above, FIG. 1A illustrates the case in which the first electrode 120 functions as a cathode, and the diodes 220a and 220b are arranged according to the polarity of the first electrode 120. On the other hand, FIG. 1B illustrates the case in which the first electrode 120 functions as an anode, and the diodes 220a and 220b are arranged in the opposite direction of the case of FIG. 1A.

The first electrode 120 may be formed of a transparent or semi-transparent material, or an opaque material.

Exemplary embodiments for a case in which the first electrode 120 is formed of a transparent or semi-transparent material and a case in which the first electrode 120 is formed of an opaque material will be described later with reference to related drawings.

The second electrode 140a and the third electrode 140b have the same polarity, which is opposite to that of the first electrode 120. The second electrode 140a and the third electrode 140b may be formed of a transparent or semi-transparent material.

A light-emitting unit includes the first light-emitting unit 130a and the second light-emitting unit 130b. The first light-emitting unit 130a is formed between the first electrode 120 and the second electrode 140a, and the second light-emitting unit 130b is formed between the first electrode 120 and the third electrode 140b.

The light-emitting unit may have one structure selected from an organic light-emitting layer, a hole injection layer/organic light-emitting layer, an organic light-emitting layer/electron injection layer, a hole-injection layer/organic light-emitting layer/electron injection layer, a hole injection layer/hole transport layer/organic light-emitting layer/electron injection layer, a hole injection layer/organic light-emitting layer/electron transport layer/electron injection layer, and a hole injection layer/hole transport layer/organic light-emitting layer/electron transport layer/electron injection layer.

When the first light-emitting unit 130a is a standard type, the second light-emitting unit 130b is an inverted type. On the other hand, when the first light-emitting unit 130a is the inverted type, the second light-emitting unit 130b is the standard type.

The drive controller 200 is electrically connected with the first electrode 120, the second electrode 140a and the third electrode 140b through a first electrode line 240a and a second electrode line 240b to connect the first light-emitting unit 130a and the second light-emitting unit 130b in parallel, and causes the first light-emitting unit 130a and the second light-emitting unit 130b to emit light at the same time or different times. The electrode lines 240a and 240b may be metal interconnections, or may be any interconnections for electrical connection.

The drive controller 200 includes a first voltage regulation unit 230a that is electrically connected with the second electrode 140a and regulates an applied voltage, a second voltage regulation unit 230b that is electrically connected with the third electrode 140b and regulates an applied voltage, the first electrode line 240a that connects the first voltage regulation unit 230a with the second electrode 140a, the second electrode line 240b that connects the second voltage regulation unit 230b with the third electrode 140b, and diodes 220a and 220b that are formed between the first electrode line 240a and the second electrode line 240b and control the direction of a current between the first electrode 120 and the second electrode 140a and between the first electrode 120 and the third electrode 140b, respectively.

The first voltage regulation unit 230a and the second voltage regulation unit 230b regulate voltages applied to the second electrode 140a and the third electrode 140b to control light-emission of the first light-emitting unit 130a and the second light-emitting unit 130b, respectively. To be specific, by controlling whether or not to apply a voltage and the level of an applied voltage, the first voltage regulation unit 230a and the second voltage regulation unit 230b control an on-off state of the first light-emitting unit 130a and the second light-emitting unit 130b, and brightness, color, etc., of the emitted light.

The first electrode line 240a electrically connects the first voltage regulation unit 230a with the second electrode 140a, and the second electrode line 240b electrically connects the second voltage regulation unit 230b with the third electrode 140b.

The diodes 220a and 220b are formed between the first electrode line 240a and the second electrode line 240b, and determine the direction of a current. Referring to FIGS. 1A and 1B, it can be seen that the diodes 220a and 220b are arranged according to the polarity of the first electrode 120.

An exemplary embodiment of the present invention with the above-described constitution has the light-emitting units connected in parallel and thus can be driven at a low voltage.

Also, in the present invention, it is possible to control an emission direction, brightness, and color by controlling light emission of light-emitting units. Respective exemplary embodiments will be described below with reference to related drawings.

As described above, in the present invention, the first electrode 120, which is the common electrode, may function as a cathode or anode, and the arrangement of the diodes 220a and 220b included in the drive controller 200 may be changed according to the polarity of the first electrode 120. For convenience, exemplary embodiments for the case in which the first electrode 120, which is the common electrode, functions as a cathode will be described below. As mentioned above, however, the exemplary embodiments described below can also be applied to the case in which the first electrode 120, which is the common electrode, functions as an anode.

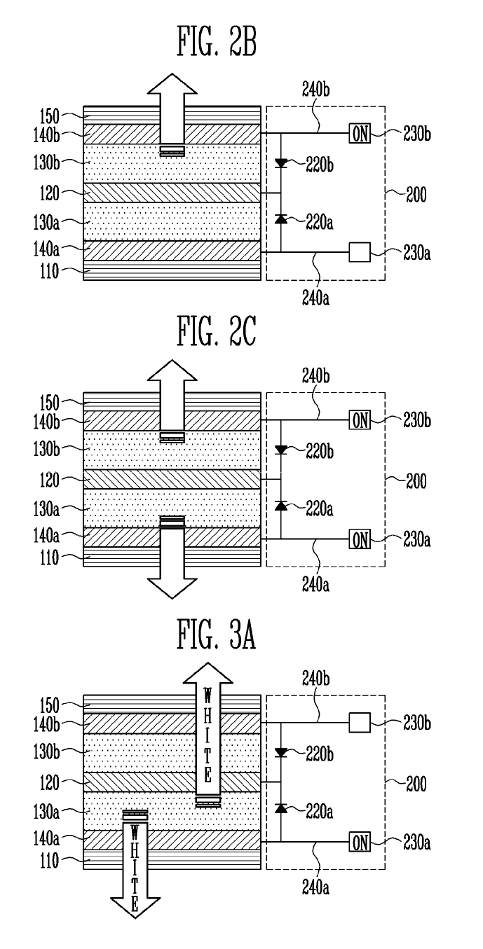

FIG. 2 illustrates emission direction control of a stacked organic light-emitting device according to an exemplary embodiment of the present invention. In an exemplary embodiment of the present invention described with reference to FIG. 2, the first electrode 120, which is a common electrode, is an opaque electrode formed of an opaque material.

FIG. 2A illustrates a case in which the first voltage regulation unit 230a is in an ON state, and the second voltage regulation unit 230b is in an OFF state. In this case, a current output from the first voltage regulation unit 230a is input to the first electrode 120 via the first diode 220a but cannot be input to the third electrode 140b due to the second diode 220b. Thus, only the first light-emitting unit 130a emits light, and the second light-emitting unit 130b does not emit light.

Also, since the first electrode 120 in FIG. 2 is an opaque electrode, light emitted from the first light-emitting unit 130a cannot be emitted to the upper side of the device.

Consequently, as illustrated in the drawing, light is emitted downward.

FIG. 2B illustrates a case in which the first voltage regulation unit 230a is in the OFF state, and the second voltage regulation unit 230b is in the ON state. In this case, a current output from the second voltage regulation unit 230b is input to the first electrode 120 via the second diode 220b but cannot be input to the second electrode 140a due to the first diode 220a. Thus, the first light-emitting unit 130a does not emit light, and only the second light-emitting unit 130b emits light.

Also, since the first electrode 120 is an opaque electrode, light emitted from the second light-emitting unit 130b cannot be emitted to the lower side of the device.

Consequently, as illustrated in the drawing, light is emitted upward.

FIG. 2C illustrates a case in which both the first voltage regulation unit 230a and the second voltage regulation unit 230b are in the ON state. In this case, a current output from the first voltage regulation unit 230a is input to the first electrode 120 via the first diode 220a, and a current output from the second voltage regulation unit 230b is input to the first electrode 120 via the second diode 220b. Thus, both the first light-emitting unit 130a and the second light-emitting unit 130b emit light.

Consequently, as illustrated in the drawing, light is emitted in both of the directions.

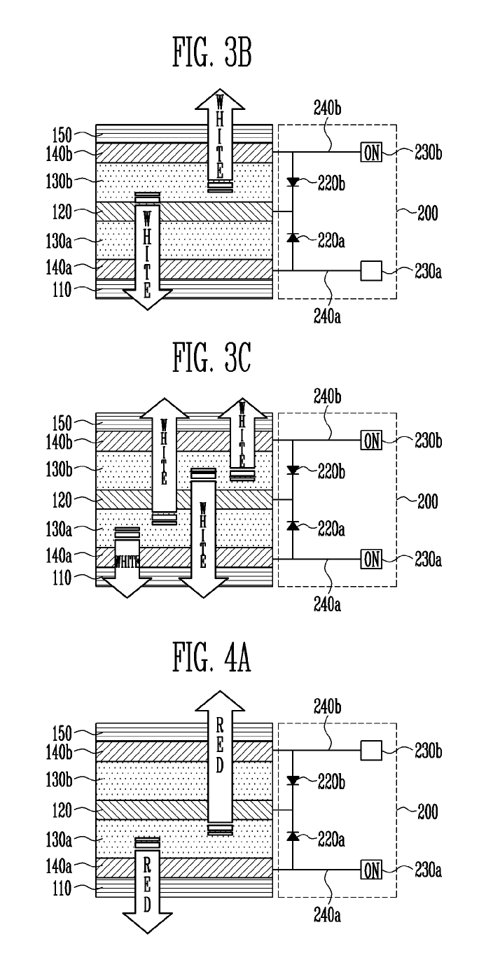

FIG. 3 illustrates brightness control of a stacked organic light-emitting device according to an exemplary embodiment of the present invention. In an exemplary embodiment of the present invention described with reference to FIG. 3, the first electrode 120, which is a common electrode, is formed of a transparent or semi-transparent material. Meanwhile, in FIG. 3, both the first light-emitting unit 130a and the second light-emitting unit 130b emit a white color, but the color may vary according to a user's intention.

FIG. 3A illustrates a case in which the first voltage regulation unit 230a is in the ON state, and the second voltage regulation unit 230b is in the OFF state. In this case, a current output from the first voltage regulation unit 230a is input to the first electrode 120 via the first diode 220a but cannot be input to the third electrode 140b due to the second diode 220b. Thus, only the first light-emitting unit 130a emits light, and the second light-emitting unit 130b does not emit light.

However, since the first electrode 120 in FIG. 3 is a transparent or semi-transparent electrode, light emitted from the first light-emitting unit 130a is emitted to the upper side of the device. As a result, the light is emitted in both of the directions as illustrated in the drawing.

FIG. 3B illustrates a case in which the first voltage regulation unit 230a is in the OFF state, and the second voltage regulation unit 230b is in the ON state. In this case, not the first light-emitting unit 130a, but the second light-emitting unit 130b emits light, unlike the case of FIG. 3A.

However, since the first electrode 120 is a transparent or semi-transparent electrode, light emitted from the second light-emitting unit 130b is emitted to the lower side of the device. As a result, the light is emitted to both of the directions as illustrated in the drawing.

FIGS. 3A and 3B illustrate the cases in which only one light-emitting unit emits light in both of the directions. On the other hand, when both of the light-emitting units emit light, brightness of the emitted light increases. This case is illustrated in FIG. 3C.

FIG. 3C illustrates a case in which both the first voltage regulation unit 230a and the second voltage regulation unit 230b are in the ON state. In this case, currents output from the first voltage regulation unit 230a and the second voltage regulation unit 230b are input to the first electrode 120 via the first diode 220a and the second diode 220b, respectively. Thus, both the first light-emitting unit 130a and the second light-emitting unit 130b emit light.

Meanwhile, since the first electrode 120 in FIG. 3 is a transparent or semi-transparent electrode, all light emitted from the first light-emitting unit 130a and the second light-emitting unit 130b is emitted in both of the directions. Thus, brightness of the emitted light becomes double that of the exemplary embodiments described with reference to FIGS. 3A and 3B.

As described above, in the exemplary embodiments described with reference to FIG. 3, it is possible to control the brightness of emitted light. Also, even if only one of the light-emitting units 130a and 130b is driven, it is possible to control the brightness of emitted light by controlling an applied voltage.

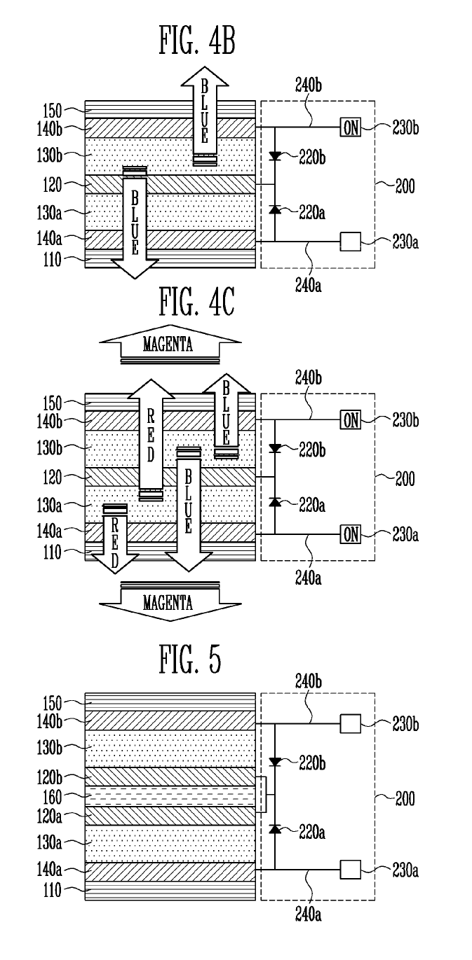

FIG. 4 illustrates color control of a stacked organic light-emitting device according to an exemplary embodiment of the present invention. In an exemplary embodiment of the present invention described with reference to FIG. 4, the first electrode 120, which is a common electrode, is formed of a transparent or semi-transparent material. Meanwhile, in FIG. 4, the first light-emitting unit 130a and the second light-emitting unit 130b are configured to emit light of a red color and light of a blue color respectively, but the colors may vary according to a user's intention.

Referring to FIG. 4C, it can be seen that both the first voltage regulation unit 230a and the second voltage regulation unit 230b are in the ON state, and thus both the first light-emitting unit 130a and the second light-emitting unit 130b emit light, as in the case of FIG. 3C.

In this case, as illustrated in the drawing, both red light RED emitted from the first light-emitting unit 130a and blue light BLUE emitted from the second light-emitting unit 130b are output in both of the directions.

The red light emitted from the first light-emitting unit 130a and the blue light emitted from the second light-emitting unit 130b are mixed, and a magenta color MAGENTA is seen from the outside of the device.

Here, a color temperature may be adjusted by controlling applied voltages of the first light-emitting unit 130a and the second light-emitting unit 130b. To be specific, by increasing or decreasing a voltage applied to the first light-emitting unit 130a which emits the red color or a voltage applied to the second light-emitting unit 130b which emits the blue color, a color temperature can be adjusted.

As described above, in the exemplary embodiment described with reference to FIG. 4, when the first light-emitting unit 130a and the second light-emitting unit 130b are configured to emit desired light, the color of the emitted light can be controlled by regulating applied voltages.

Also, by regulating voltages applied to the two light-emitting units 130a and 130b while maintaining the voltages to be identical to each other, it is possible to adjust the brightness of emitted light.

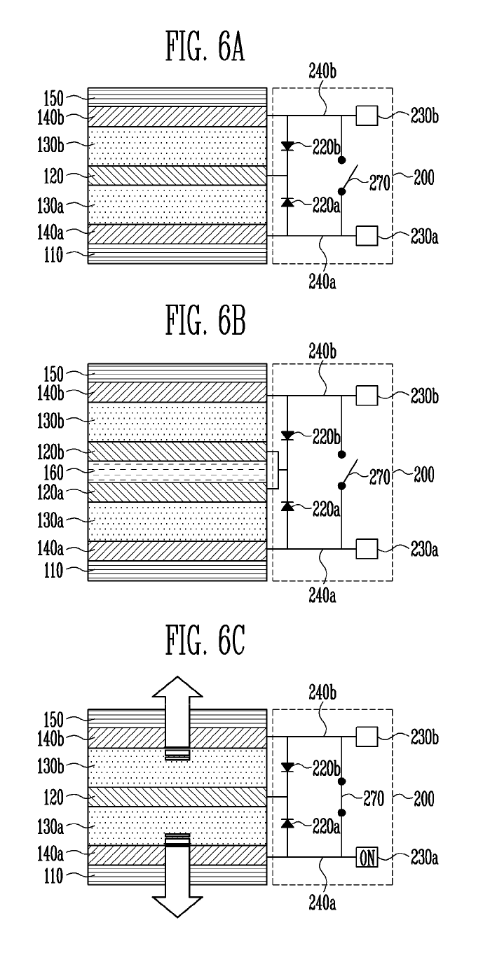

Meanwhile, when a cathode or anode is used as a common electrode for two light-emitting units, brightness may become uneven due to heat generation and voltage drop. An exemplary embodiment of the present invention for solving this problem will be described below with reference to FIG. 5.

FIG. 5 illustrates a stacked organic light-emitting device in which an insulating layer is inserted according to an exemplary embodiment of the present invention.

In FIG. 5, unlike the above-described exemplary embodiments, a common electrode is divided into two electrodes 120a and 120b, and an insulating layer 160 is inserted between them. Other components are the same as described above in the exemplary embodiments.

When a light-emitting device is formed as illustrated in FIG. 5, each light-emitting unit has its own cathode or anode, and thus it is possible to solve the problem of uneven brightness caused by heat generation and voltage drop.

Like the above-described exemplary embodiments, in the exemplary embodiment illustrated in FIG. 5, the electrodes 120a and 120b may be transparent, semi-transparent, or opaque, and electrodes 140a and 140b may be transparent or semi-transparent. When the electrodes 120a and 120b are transparent or semi-transparent, the insulating layer 160 is preferably formed of a transparent or semi-transparent material. Also, like the above-described exemplary embodiments, the first light-emitting unit 130a and the second light-emitting unit 130b may be configured to emit light of the same color or different colors, and it is possible to control an emission direction and the brightness and color of the emitted light by controlling an applied voltage.

Meanwhile, when the thickness of the insulating layer 160 is determined in consideration of the transmissivity and refractive index of the insulating layer 160, it is possible to control the amount of light and color of light emitted from the device. In other words, when the device is formed in consideration of the transmissivity and refractive index of the insulating layer 160 and the optical length of each light-emitting unit, the amount and color of light can be adjusted due to a microcavity effect.

Like the above-described exemplary embodiments, the exemplary embodiment described with reference to FIG. 5 can also be applied to a case in which the electrodes 120a and 120b are anodes.

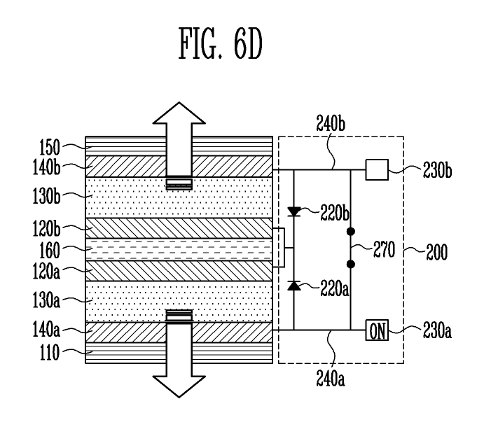

Meanwhile, when both of the two light-emitting units are driven in the above-described exemplary embodiments, both of the two voltage regulation units 230a and 230b must be driven. An exemplary embodiment for solving this problem will be described below with reference to FIG. 6.

FIG. 6 illustrates a stacked organic light-emitting device in which an additional driving switch 270 is formed according to another exemplary embodiment of the present invention.

Referring to FIGS. 6A and 6B, the additional driving switch 270 is formed between the first electrode line 240a and the second electrode line 240b. Other components are the same as described above in the exemplary embodiments.

When the additional driving switch 270 is formed as mentioned above, only one voltage regulation unit may be used to drive both of the two light-emitting units 130a and 130b.

FIGS. 6C and 6D illustrate cases in which both of the two light-emitting units 130a and 130b are driven by only one voltage regulation unit.

FIG. 6C illustrates a case in which both the first light-emitting unit 130a and the second light-emitting unit 130b are driven by the first voltage regulation unit 230a and the additional driving switch 270 when the first electrode 120 is an opaque cathode, and FIG. 6D illustrates a case in which both the first light-emitting unit 130a and the second light-emitting unit 130b are driven by the first voltage regulation unit 230a and the additional driving switch 270 when the electrodes 120a and 120b are opaque cathodes and the insulating layer 160 is formed between the electrodes 120a and 120b. Here, both of the two light-emitting units 130a and 130b may be driven by the second voltage regulation unit 230b instead of the first voltage regulation unit 230a.

This method of driving both of the two light-emitting units using the additional driving switch 270 can be applied to all the above-described exemplary embodiments even if the electrodes 120, 120a and 120b are anodes, the electrodes 120, 120a and 120b are semi-transparent or transparent, or the first light-emitting unit 130a and the second light-emitting unit 130b emit light of the same color or different colors.

As described above, in an exemplary embodiment of the present invention, respective light-emitting units are connected in parallel so that an organic light-emitting device having a lower driving voltage than a conventional stacked light-emitting device in which light-emitting units are serially connected can be provided.

Also, it is possible to provide an organic light-emitting device capable of controlling an emission direction, brightness, and color.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A stacked organic light-emitting device, comprising:
a first electrode;
first and second light-emitting units formed under and on the first electrode, respectively;
transparent or semi-transparent second and third electrodes formed under the first light-emitting unit and on the second light-emitting unit respectively, and having the same polarity; and
a drive controller electrically connected with the first, second and third electrodes to connect the first and second light-emitting units in parallel, and controlling at least one of the first and second light-emitting units to emit light.

2. The stacked organic light-emitting device of claim 1, wherein the drive controller includes:
a first voltage regulation unit for regulating a voltage applied to the second electrode; and
a second voltage regulation unit for regulating a voltage applied to the third electrode.

3. The stacked organic light-emitting device of claim 2, wherein the drive controller further includes:
a first electrode line for connecting the second electrode with the first voltage regulation unit;
a second electrode line for connecting the third electrode with the second voltage regulation unit;
a first diode for connecting the first electrode with the second electrode and arranged in a direction corresponding to a polarity of the first electrode; and
a second diode for connecting the first electrode with the third electrode and arranged in a direction corresponding to the polarity of the first electrode.

4. The stacked organic light-emitting device of claim 3, wherein the drive controller further includes an additional driving switch formed between the first electrode line and the second electrode line and enabling electrical on-off control so that both the first and second light-emitting units emit the light in an ON state of the first voltage regulation unit or the second voltage regulation unit.

5. The stacked organic light-emitting device of claim 1, wherein the first electrode is formed of an opaque material.

6. The stacked organic light-emitting device of claim 5, wherein an emission direction is controlled in an upward direction, in a downward direction, or in both of the directions by the drive controller.

7. The stacked organic light-emitting device of claim 1, wherein the first electrode is formed of a transparent or semi-transparent material.

8. The stacked organic light-emitting device of claim 7, wherein the first and second light-emitting units are formed of materials emitting light of the same color, and brightness is adjusted by the drive controller.

9. The stacked organic light-emitting device of claim 7, wherein the first and second light-emitting units are formed of materials emitting light of different colors, and brightness and color are adjusted by the drive controller.

10. The stacked organic light-emitting device of claim 1, wherein the first light-emitting unit and the second light-emitting unit have one structure selected from an organic light-emitting layer, a hole injection layer/organic light-emitting layer, an organic light-emitting layer/electron injection layer, a hole-injection layer/organic light-emitting layer/electron injection layer, a hole injection layer/hole transport layer/organic light-emitting layer/electron injection layer, a hole injection layer/organic light-emitting layer/electron transport layer/electron injection layer, and a hole injection layer/hole transport layer/organic light-emitting layer/electron transport layer/electron injection layer.

11. A stacked organic light-emitting device, comprising:
an insulating layer;
first and second electrodes formed under and on the insulating layer respectively, and having the same polarity;
first and second light-emitting units formed under the first electrode and on the second electrode, respectively;
transparent or semi-transparent third and fourth electrodes formed under the first light-emitting unit and on the second light-emitting unit respectively, and having the same polarity; and
a drive controller electrically connected with the first, second, third and fourth electrodes to connect the first and second light-emitting units in parallel, and controlling at least one of the first and second light-emitting units to emit light.

12. The stacked organic light-emitting device of claim 11, wherein the drive controller includes:
a first voltage regulation unit for regulating a voltage applied to the third electrode; and
a second voltage regulation unit for regulating a voltage applied to the fourth electrode.

13. The stacked organic light-emitting device of claim 12, wherein the drive controller further includes:
a first electrode line for connecting the third electrode with the first voltage regulation unit;
a second electrode line for connecting the fourth electrode with the second voltage regulation unit;
a first diode for connecting the first electrode with the third electrode and arranged in a direction corresponding to the polarity of the first electrode; and
a second diode for connecting the second electrode with the fourth electrode and arranged in a direction corresponding to the polarity of the second electrode.

14. The stacked organic light-emitting device of claim 13, wherein the drive controller further includes an additional driving switch formed between the first electrode line and the second electrode line and enabling electrical on-off control so that both the first and second light-emitting units emit the light in an ON state of the first voltage regulation unit or the second voltage regulation unit.

15. The stacked organic light-emitting device of claim 11, wherein the first and second electrodes are formed of an opaque material.

16. The stacked organic light-emitting device of claim 15, wherein an emission direction is controlled in an upward direction, in a downward direction, or in both of the directions by the drive controller.

17. The stacked organic light-emitting device of claim 11, wherein the first and second electrodes are formed of a transparent or semi-transparent material.

18. The stacked organic light-emitting device of claim 17, wherein the first and second light-emitting units are formed of materials emitting light of the same color, and brightness is adjusted by the drive controller.

19. The stacked organic light-emitting device of claim 17, wherein the first and second light-emitting units are formed of materials emitting light of different colors, and brightness and color are adjusted by the drive controller.

20. The stacked organic light-emitting device of claim 11, wherein a thickness of the insulating layer is determined based on a transmissivity and refractive index of the insulating layer and an optical length of the first and second light-emitting units so that an amount and color of the light are adjusted due to a microcavity effect.
